(19) United States
(12) Patent Application Publication
(10) Pub. No.: US 2025/0019132 A1
(43) Pub. Date: Jan. 16, 2025

(54) REUSABLE STOPPER FOR BEVERAGE CONTAINER LID

(71) Applicant: Cara Brzezicki, Littleton, CO (US)

(72) Inventor: Cara Brzezicki, Littleton, CO (US)

(73) Assignee: Cara Brzezicki, Littleton, CO (US)

(21) Appl. No.: 18/745,990

(22) Filed: Jun. 17, 2024

Related U.S. Application Data
(60) Provisional application No. 63/513,562, filed on Jul. 13, 2023.

(51) Int. Cl. B65D 47/12

(52) U.S. Cl. CPC B65D 47/121

(57) ABSTRACT

The disclosure presented herein relates to a reusable stopper (1) for temporarily sealing a hole in a beverage container lid (9), comprising a reusable stopper (1, 2, 3, 4, 5, 6, 7, 8) having a top portion (6, 7, 8), the stem (2), and a bottom portion (3, 4, 5) and the plug portion (4) to be inserted and removed in the hole while retaining a proper seal against splashing and/or spilling.

### CROSS-REFERENCE TO RELATED APPLICATIONS

This application claims priority to U.S. Provisional application No. 63/513,562, filed on Jul. 13, 2023. The content of the above application is incorporated by reference in its entirety.

### BACKGROUND OF THE INVENTION

### Prior Art

### Field of Classification Search

CPC . . . . . . . . . B65D 51/18; B65D 39/00; B65D 41/18; A47G 19/22; B65D 51/00; B65D 55/00

### REFERENCES CITED

### U.S. Patent Documents

U.S. Pat. No. 2,841,307 1956 Nov. 1 Yoder
2006/0016823 A1 2006 Jan. 26 Noon
2007/0023442 A1 2007 Feb. 1 Auzenne
U.S. Pat. No. 8,839,985 B1 2014 Sep. 23 SANCHEZ
U.S. Pat. No. 9,216,846 B2 2015 Dec. 22 Burns

There are many beverage containers, which are usually made in bulk from plastic or paper. There are openings in the lids to allow a user to drink out of one opening and the smaller opening is used as a venting hole to allow a steady flow of liquid out of the lid. The larger opening for drinking is constantly open allowing air to either cool the beverage or allow hot air to warm the beverage. If the beverage spills, the opening will allow the liquid to pour out. I have found many attempts to prevent splashing and/or spillage have been used as disposable and non-ecofriendly plugs, but these eventually end up in the landfill and aid in climate change and never fully break down.

### SUMMARY OF THE INVENTION

In an aspect herein, a reusable device that seals an opening in a beverage container lid that prevents splashing and/or spillage to aid in keeping the thermal properties inside the container. A reusable stopper having features of a top portion, stem, bottom portion with a plug. The stem attached to the plug is to be inserted into the opening of the beverage container lid to provide a repeated removal and insertion seal.

### BRIEF DESCRIPTION OF DRAWINGS

FIG. 1 is a perspective front view of a reusable stopper, constructed in accordance with the invention, showing the top and bottom.

FIG. 2 is a perspective bottom view of the plug portion of the reusable stopper of FIG. 1.

FIG. 3 is a perspective front view of a beverage container and beverage container lid in accordance with prior art and a reusable stopper of FIG. 1 showing where the reusable stopper is plugged into the beverage container lid.

FIG. 4 is a perspective top view of a beverage container lid of part of FIG. 3 depicting the hole in accordance wit the prior art.

FIG. 5 is a perspective top view of the inside of a beverage container lid in accordance with prior art of FIG. 4, depicting the bottom portion or plug area of the reusable stopper.

FIG. 6 is a perspective front view of a beverage container and beverage container lid of FIG. 1 and FIG. 3 in accordance with the prior art, depicting a see-through area to show the reusable stopper completely plugged in to the beverage container lid.

### REFERENCE NUMERALS

1 reusable stopper
2 stem
3 bottom portion
4 plug portion
5 spacer
6 logo
7 design
8 top portion
9 beverage container
10 beverage container lid
11 hole
12 see-through area
13 liquid

### DETAILED DESCRIPTION

In the Summary above and in this Detailed Description, and the claims below, and the accompanying drawings, reference is made to particular features (including method steps) of a reusable stopper.

In an aspect herein, a reusable device that seals an opening in a beverage container lid.

In one aspect, a reusable stopper having features of a top portion, stem, bottom portion with a plug. The stem attached to the plug is to be inserted into the opening of the beverage container lid to provide a repeated removal and insertion seal.

Most often, the reusable device will meet the requirements of a lid for a beverage container. Such lid is comprised of a hole, comprising the steps of: providing the reusable stopper to plug the hole temporarily sealing the beverage container lid, and the removal. The plug portion is positioned to lock underneath the hole in the beverage container lid. This provides a temporary seal.

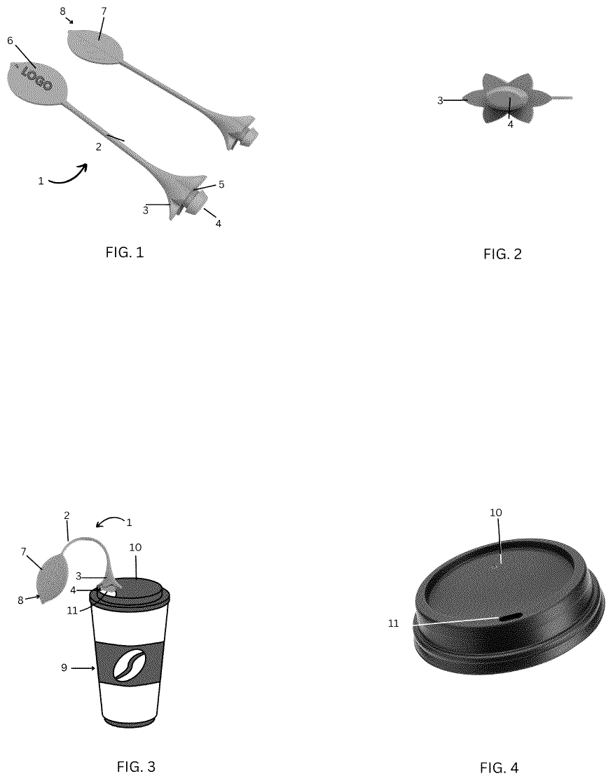

Looking at the several figures of the drawing, where FIG. 1 is a perspective view from the top view of a reusable stopper 1 with a top and bottom side constructed in accordance with one embodiment. The stem 2 is connected to the bottom area 3 which is connected to spacer 5, which is connected to plug portion 4 to be inserted and released into hole 11 (not shown) of beverage container lid 10 (not shown) to limit splashing. The top of stem 2 is connected to a top portion 8, which can have a logo 6 on one side or both, and/or have design 7 on one side or both. In preferred embodiments of the invention, the plug portion 4 will be shaped to securely fit in the beverage container lid 10 (not shown), preferably, underneath container lid 10 (not shown).

In preferred embodiments, as depicted in FIG. 2, the plug portion 4 is facing toward the user from the bottom of reusable stopper 1, should fit nicely in a beverage container lid 10 (not shown) where the bottom area 3 covers the hole completely. Preferably, the plug portion 4 will be in an oval shape to accommodate the hole 11 (not shown), which is approximately the shape of the hole 11 (not shown) on the beverage container lid 10 (not shown). Alternatively, another shape used for such a hole will be smaller in size than the plug portion 4 to allow plug portion 4 to fit nicely.

As depicted in FIG. 1, the stem 2 of reusable stopper 1 will desirably flow outwardly to be wider at the bottom portion 3. The spacer 5 aids in the locking from underneath hole 11 (not shown) on lid 10 (not shown). The cross section of plug portion 4 will be wider than the cross section of the hole 11 (not shown) of lid 10 (not shown) to allow liquid to stay in beverage container 9 (not shown) and create a temporary seal. In such embodiments, the stem 2 connected to the top portion 8 can be of any shape desired. The top portion 8 allows a user to easily grab the reusable stopper 1 to insert and remove the reusable stopper 1. In preferred embodiments, top portion 8 will allow the placement of logos, messages for advertising on a logo 6. Either side of the top portion 8 can allow the logos, and the like, whether it be on the logo 6 side or on a design side 7. The design side 7 will allow a design, or the placement of logos, and the like.

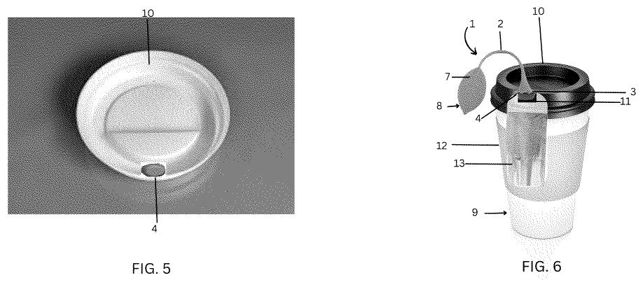

As will be seen in FIG. 5, plug portion is a top view of the inside of beverage container lid 10 with the bottom of plug portion 4 showing through beverage container lid 10. Allowing the user to temporarily stop up the hole 11 (not shown). The width of plug portion 4 completely covers hole 11. The spacer 5 (not shown) allows bottom portion 3 (not shown) to sit above lid 10 and plug portion 4 to lock from underneath lid 10.

Preferably, reusable stopper 1 comprises of food-grade silicone, preferably comprising a hardness of about 30 degrees. Alternatively, the reusable stopper may be formed of a similar material, preferably a reusable material.

Although the described preferred embodiments of this aspect herein, it will be understood to those of ordinary skill that the aspect herein that includes certain modifications and changes may be made without being removed from the above descriptions and below claims.

What is claimed is:

1. A reusable stopper to temporarily plug a drinking hole in a beverage container lid, the reusable stopper comprising:
a. a reusable stem portion connected to a plug portion
b. where the plug portion can be reinserted and removed in the beverage container lid and
c. the upper portion allows a user to grab the reusable stopper for removal and reinsertion.

2. The reusable stopper of claim 1, wherein the plug portion locks into place underneath the beverage container lid.

3. The reusable stopper of claim 2, wherein the plug portion is configured to be wider at bottom of the plug portion.

4. The reusable stopper of claim 3, wherein the bottom of the plug portion comes into contact with a beverage container lid, configured to provide the reusable stopper to stay in contact with the beverage container lid.

5. The reusable stopper of claim 1, wherein the stem is wider at the lower surface.

6. The stem of claim 5, wherein the stem's lower surface is connected to the plug portion.

7. The reusable stopper of claim 6, wherein the stem is connected to a top portion.

8. The reusable stopper of claim 7, wherein the top portion can be of any shape.

9. The reusable stopper of claim 8, wherein the top portion can have different logos for advertising means.

10. The reusable stopper of claim 9, wherein the top portion and the stem are configured to allows a user to insert and remove the reusable stopper from the beverage container lid.
